(19) United States
(12) Patent Application Publication
(10) Pub. No.: US 2026/0273559 A1
(43) Pub. Date: Sep. 17, 2026

(54) TRIGGER PUMPS

(71) Applicant: OBRIST CLOSURES SWITZERLAND GMBH, Muttenz (DE)

(72) Inventors: Patrick SCHMIDT, Zell-Kaimt (DE); Klaus NATERSKY, Grenderich (DE); Christian WILHELMS, Blankenrath (DE)

(21) Appl. No.: 19/472,210

(22) PCT Filed: Apr. 4, 2024
(86) PCT No.: PCT/EP2024/059253

§ 371 Date: Oct. 3, 2025

(30) Foreign Application Priority Data
Apr. 4, 2023 (GB) 2305012.3

(51) Int. Cl. B05B 11/10

(52) U.S. Cl. CPC B05B 11/1011; B05B 11/1057; B05B 11/1074

(57) ABSTRACT

The invention relates to a trigger pump dispenser comprising—a main body, comprising—a pump chamber—an inlet port in communication with said pump chamber—an outlet port in communication with said pump chamber—an inlet valve seated between the pump chamber and the inlet port—a outlet valve seated between the pump chamber and the outlet port—a piston, seated in the pump chamber, for defining a variable volume in said pump chamber and movable between a retracted position of larger chamber volume and an inserted position of lesser chamber volume,—wherein the pump chamber has a conical shape.

The present invention relates to dispensers for liquid products and particularly to so-called “trigger pumps” of the kind which have a trigger operable to drive a piston along a pump chamber and so to force liquid product under pressure from the pump chamber and through a dispensing orifice in a nozzle.

Known trigger pumps are described in WO2022023579.

In the plastic packaging industry, there has been a growing emphasis on sustainability and reducing environmental impact. This led to an increase in the use of recycled plastic materials in the production of plastic packaging products.

As the use of recycled plastic in packaging becomes more prevalent, new challenges arise to ensure the quality and consistency of the products. Recycled plastic materials have not the same property as virgin plastic materials, which can affect the performance and appearance of the final packaging product.

It has been found that in dispensers having a pump chamber and a piston, made of a mix of recycled plastic and virgin plastic, leak between the piston and the pump chamber appears sooner than a pump chamber and a piston made of virgin plastic only.

The objective of this invention is to create a product that can be manufactured using either virgin, recycled, or a combination of both materials, while still maintaining high performance standards.

According to a first aspect, the invention relates to a trigger pump dispenser comprising
a main body, comprising
a pump chamber
an inlet port in communication with said pump chamber
an outlet port in communication with said pump chamber
an inlet valve seated between the pump chamber and the inlet port
an outlet valve seated between the pump chamber and the outlet port
a piston, seated in the pump chamber, for defining a variable volume in said pump chamber and movable between a retracted position of larger chamber volume and an inserted position of lesser chamber volume,
wherein the pump chamber has a conical shape.

The conical shape of the pump chamber permits to prevent or at least delay leak, especially for a pump chamber and a piston comprising recycled plastic.

The pump chamber having a conical shape means that the pump chamber is essentially a conical frustum open on both ends. The bigger end is opened so as to allow the insertion of a piston inside the pump chamber. The smaller end is opened so as to allow the passage of a liquid in and out of the pump chamber through the inlet valve and the outlet valve.

In some embodiments, the pump chamber is characterized by a conical shape of the pump chamber having a half-angle from 0.1° to 0.5° and preferably from 0.2° to 0.4°. Without to be bound by any theory, this half-angle range provides the optimal leak prevention.

In the context of this patent, the half-angle of the conical pump chamber is the angle formed by the intersection of a plane passing through one of the sloping sides of the conical pump chamber and the axis of revolution of the conical pump chamber.

It has been observed that in most embodiments, the movement of the piston is not a linear movement but rather a slightly curved movement. Consequently, solutions are needed to prevent leak between the piston and the outer wall of the piston chamber.

The piston is defined by a length and comprises a first sealing lip having a defined length and a defined thickness, and a second sealing lip having a defined length and a defined thickness.

In some embodiments, the ratio between the length of the first sealing lip and the length of the second sealing lip is from 2 to 6 and preferably from 3 to 5. Such a ratio permits to prevent said leak.

In some embodiments, the ratio between the length of the first sealing lip and the thickness of the first sealing lip is from 9 to 18. In some embodiments, the ratio between the length of the second sealing lip and the thickness of the second sealing lip is from 3.5 to 8. Such a ratio permits to prevent said leak.

In some embodiments, the ratio between the length of the first sealing lip and average diameter of the pump chamber is from 0.51 to 0.61, preferably from 0.53 to 0.59. In some embodiments, the ratio between the length of the second sealing lip and average diameter of the pump chamber is from 0.08 to 0.18 and preferably from 0.10 to 0.16. Such a ratio permits to prevent said leak.

In the present description and claims, the terms “average diameter of the pump chamber is to be understood as average value between the diameters of the two open-sides of the pump chamber.

The present invention will now be more particularly described with reference to, and as shown in, the accompanying drawings in which:

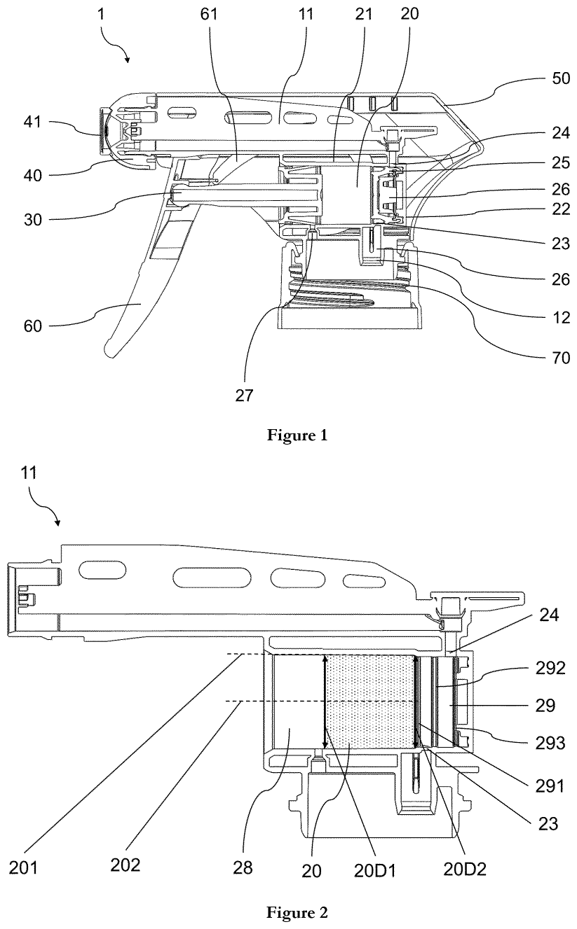

FIG. 1 illustrates a sectional view of trigger pump dispenser according to various embodiments of the invention.

FIG. 2 illustrates a sectional view of main body of a trigger pump dispenser according to various embodiments of the invention.

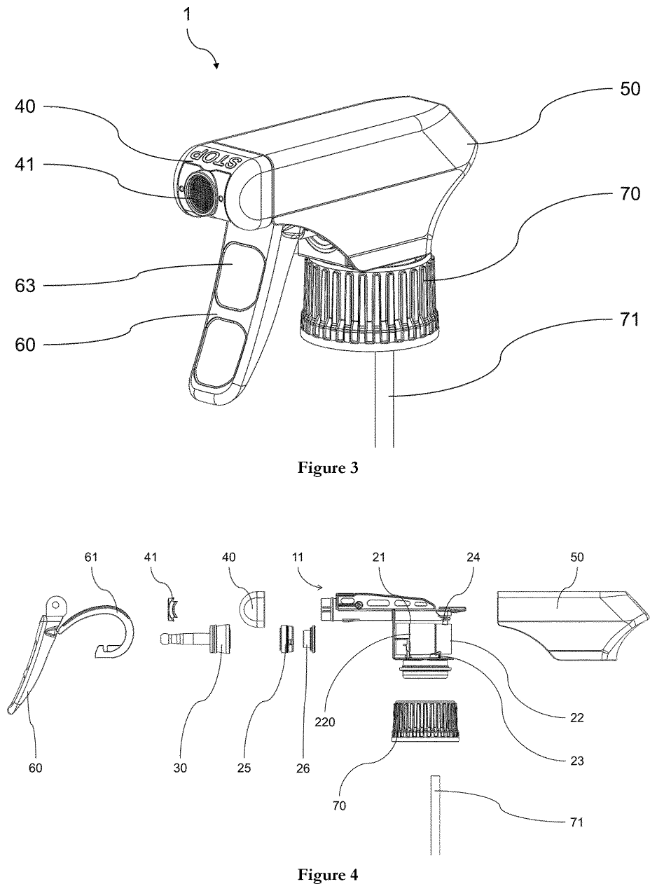

FIG. 3 illustrates a perspective view of a trigger pump dispenser according to various embodiments of the invention.

FIG. 4 illustrates an exploded view of a trigger pump dispenser according to various embodiments of the invention.

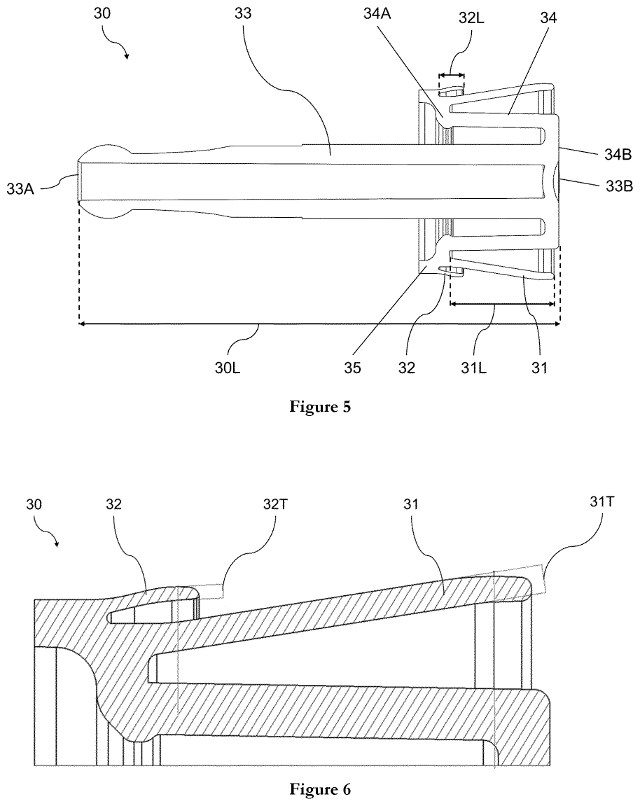

FIG. 5 illustrates a sectional view of a piston according to various embodiments of the invention.

FIG. 6 illustrates a sectional view of a portion of a piston according to various embodiments of the invention.

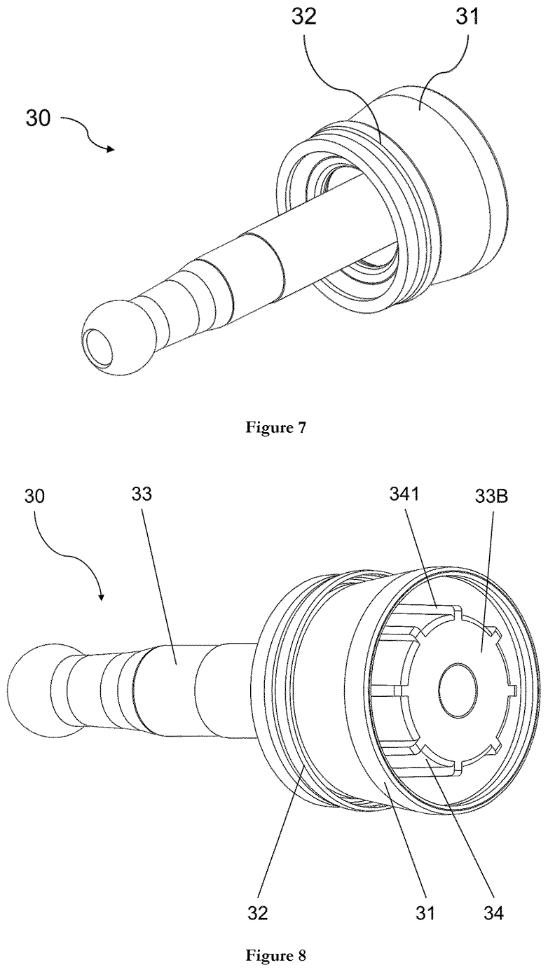

FIG. 7 illustrates a perspective view of a piston according to various embodiments of the invention.

FIG. 8 illustrates a perspective view of a piston according to various embodiments of the invention.

Different aspects and/or embodiments of the invention may be used separately or together.

Further particular and preferred aspects of the present invention are set out in the accompanying independent and dependent claims. Features of the dependent claims may be combined with the features of the independent claims as appropriate, and in combination other than those explicitly set out in the claims.

The present invention will now be more particularly described with reference to, and as shown in, the accompanying drawings.

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof. Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention.

A trigger pump dispenser according to an embodiment of the invention is illustrated in FIG. 1. The trigger pump dispenser 1 comprises a main body 11 which comprises a conical pump chamber 20. The conical pump chamber 20 comprises an outer wall 21. In this embodiment, the half-angle of the conical pump chamber 20 is of 0.3°. As illustrated in FIG. 2, the half-angle is formed by the intersection of the plane 201 passing through one of the sloping sides of the conical pump chamber 20 and the revolution axis 202 of the pump chamber 20.

The main body 11 includes an inlet port 23 and an outlet port 24 that are in communication with the pump chamber 20.

In some embodiments, as illustrated in FIG. 1, the pump chamber comprises a venting hole 27.

An inlet valve 25 is seated between the pump chamber 20 and the inlet port 23. The inlet valve is 25 adapted to open the inlet port when liquid to be dispensed is drawn into the pump chamber through the inlet port as the pump chamber volume increases when the piston is moved from the inserted position to the retracted position.

An outlet valve 26 is seated between the pump chamber 20 and the outlet port 24. The outlet valve 26 is adapted to open the outlet port when the pump chamber decreases in volume as liquid therein is dispensed through the outlet port and adapted to close when the pump chamber increases in volume. In some embodiments, the outlet valve 26 is able to deform upon the application of a force on the outlet valve 26.

In some embodiments, the outlet valve comprises a pre-compression valve operable to allow liquid through the outlet port only after a predetermined elevated pressure.

In some embodiments, as illustrated in FIG. 1, the inlet valve 25 and the outlet valve 26 can be connectable together.

In some alternative embodiments, the inlet valve and the outlet valve can be combined in a single valve performing the function of both valves.

In some embodiments, the main body 11 includes a tube retainer 12.

In some embodiments, the tube retainer 12 is integrally formed with the main body 11. In some alternative embodiments, the tube retainer may fit into a portion of the main body.

In some embodiments, the trigger pump dispenser may include an attachment system 70 for securing the trigger pump dispenser to a container.

In some embodiments, as illustrated in FIG. 1, the attachment system 70 may fit into a portion of the main body 11. In some alternative embodiments, the attachment system is integrally formed with the main body 11.

For example, the attachment system may include a bayonet attachment system moulded with the main body 11, a bayonet attachment system moulded in a separate part, a screw-type attachment system moulded as a separate part, or any other conventional attachment system.

The trigger pump dispenser comprises a piston 30 able to be seated in the pump chamber 20 and able to change the volume inside the pump chamber 20.

In some embodiments, the trigger pump dispenser may comprise a nozzle 40. In some embodiments, the nozzle 40 is fitted or mated with the main body 11. In some embodiments, the trigger pump dispenser may comprise a visor 41. The visor permits to control the dispensed liquid and protect a user and surrounding surfaces from accidental exposure.

In some embodiments, the trigger pump dispenser may comprise a shroud 50. In some embodiments, the shroud is attached or mated with the main body 11.

In some embodiments, the trigger pump dispenser comprises a trigger 60 and biasing elements 61 for biasing the trigger towards its starting position. The trigger 60 is coupled with the piston 30 and is movable from a starting position at which the piston is in the retracted position and a depressed position at which the piston is in the inserted position. The trigger 60 and the biasing elements 61 may be formed in the same component.

In some embodiments, the biasing elements may comprises a pair of mutually spaced curved spring arms.

The spring arms may be unconnected other than via the trigger. The arms may be joined to the trigger at hinge points, whereby the arms can hinge relative to the trigger in use. This can, for example, be used to provide a more powerful spring action.

It is understood that various embodiments of the invention may incorporate other trigger and biasing elements combinations, including such combinations comprising a trigger and a spring.

In some embodiments, during use, actuation of the trigger 60 causes the piston 30 to move from its retracted position to its depressed position within the pump chamber 20, reducing the chamber's internal volume and forcing the product towards the outlet port 24. This movement applies a force on the outlet valve 26, which, when exceeding a predetermined threshold, causes the outlet valve 26 to open. As a result, the product flows through the outlet valve 26, outlet port 24, and nozzle 40. Subsequently, the biasing means 61 initiates the suction stroke, during which the piston 30 moves away from the valves and back towards its retracted position, creating a vacuum within the cylinder chamber. This vacuum generates negative pressure in the pump chamber 20, causing the inlet valve 25 to collapse and allowing liquid to enter the pump chamber 20 through the inlet port 27. The piston 30 remains in its retracted position until the trigger 60 is actuated again, at which point the cycle repeats.

A sectional view of a main body 11 is illustrated in FIG. 2. The main body 11 comprises a conical pump chamber 20 which volume is represented in a dotted area. In some embodiments, the main body 11 comprises a piston housing 28 in the extension of the pump chamber 20 and towards the trigger 60. The piston housing 28 is able to house a piston in the retracted position. In some embodiments, the main body comprises a valve housing 29 in the extension of the pump chamber 20 and towards the inlet port 23 and the outlet port 24. One or more valves, such as an inlet valve and an outlet valve, can seat in this valve housing. As illustrated in FIG. 2, the valve housing 29 can comprise ribs 291, 292, 293 to keep an inlet valve seated between the pump chamber 20 and an inlet port 23 and to keep the outlet valve seated between the pump chamber and an outlet port 24. This can be performed by blocking the sides of the valves by the ribs and/or by locking the ribs into recessed section the valves.

A perspective view of a trigger pump dispenser 1 according to various embodiments of the invention is illustrated in FIG. 3. As shown, in some embodiments, the trigger pump dispenser includes a nozzle 40 fitted or mated with a main body, a visor 41, and a shroud 50 attached or mated with the main body. The trigger pump dispenser may include a trigger 60 comprising finger recesses 63. The trigger pump dispenser may include an attachment system 70 for securing the trigger pump dispenser to a container and a dip tube 71 secured.

An exploded view of a trigger pump dispenser according to various embodiments of the invention is illustrated in FIG. 4. As shown, in some embodiments, the trigger pump dispenser includes an assembly of a main body 11 comprises a pump chamber 20 having an outer wall 21 and a rear wall 22 wherein the outer wall 21 has a conical shape, an inlet port 23, an outlet port 24, an inlet valve 25, an outlet valve 26, a piston 30, a nozzle 40, a visor 41, a shroud 50, a trigger 60, biasing elements 61, attachment system 70 and a dip tube 71.

A sectional view of a piston 30 according to various embodiments of the invention is illustrated in FIG. 5 to 7.

In some embodiments, the piston 30 is a single piece comprising a piston rod 33, a piston base 34, a first sealing lip 31 and a second sealing lip 32.

As illustrated in FIG. 5, the piston rod 33 can be a tube or a hollow cylinder. A first end 33A of the piston rod 33 is able to be connected or linked to a trigger.

The piston base 34 is a cylinder, which can be opened on one end 34A and can be closed on the other end 34B, surrounding a portion of the piston rod 33.

The first sealing lip 31 is a essentially conical frustum extending from the open end 34A of the piston base, opposite to the first end 33A of the piston and away from the piston rod 33. The diameter of the first sealing lip 31 is greater opposite to the first end 33A of the piston.

In some embodiments, as illustrated in FIG. 5, the piston comprises a hollow cylinder 35 extending from the first sealing lip 31 towards the first end 33A of the piston rod 33, and having a revolution axis essentially parallel to the piston rod 33. This hollow cylinder has a greater diameter than the diameter of the piston base 34.

The second sealing lip 32 is essentially a conical frustum extending from said hollow cylinder 35, opposite to the first end 33A of the piston and away from the piston rod 33. The diameter of the second sealing lip 32 is greater opposite to the first end 33A of the piston.

As illustrated in FIGS. 5 to 7, the piston 30 can be defined by a length 30L, being the distance between its two opposite ends 33A and 33B.

The first sealing lip 31 can be defined by length 31L and a thickness 31T. As illustrated in FIG. 5, the length 31L of the first sealing lip 31 corresponds to the perpendicular distance between the two planes of the bases of the conical frustum being the first sealing lip 31. As illustrated in FIG. 6, the thickness 31T of the first sealing lip 31 is the distance perpendicular to its slant height.

The second sealing lip 32 can be defined by a length 32L and a thickness 32T. As illustrated in FIG. 5, the length 32L of the second sealing lip 32 corresponds to the perpendicular distance between the two planes of the bases of the conical frustum being the second sealing lip 32. As illustrated in FIG. 6, the thickness 32T the second sealing lip 32 is the distance perpendicular to its slant height.

In the embodiment illustrated in FIG. 5, the ratio between the length 31L of the first sealing lip 31 and the length 32L of the second sealing lip 32 is of 4.2.

In the embodiment illustrated in FIG. 6, the ratio between the length 31L and the thickness 31T is of 14.

In the embodiment illustrated in FIG. 6, the ratio between the length 32L and the thickness 32T is of 6.0.

As illustrated, the conical pump chamber 20 has an average diameter which is the average value between the diameters, 20D1 and 20D2, of the two open-sides of the pump chamber 20.

In the embodiment illustrated in FIG. 6, the ratio between the length 31L of the first sealing lip 31 and average diameter 20D of the pump chamber 20 is of 0.56.

In the embodiment illustrated in FIG. 6, the ratio between the length 32L of the second sealing lip 32 and average diameter 20D of the pump chamber 20 is of 0.13.

In some embodiments, as illustrated in FIG. 8, the piston 30 includes a base 34 comprising ribs 341. Such ribs permit to ease the demoulding of the piston. In some preferred embodiments, the piston comprises from 4 to 10 ribs. The ribs 341 extend in a direction parallel to the revolution axis of the piston base 34. In some preferred embodiments, the ribs 341 extend along the whole length of the piston base 34. In some preferred embodiments, said ribs 341 are evenly spaced around the piston base 34.

In some embodiments, the main body and the piston are formed from 10 to 100 weight percent of recycled plastic. In some embodiments, the main body and the piston are formed from 30 to 100 weight percent of recycled plastic. In some embodiments, the main body and the piston are formed from 50 to 100 weight percent of recycled plastic.

Recycled plastics, as used in this patent application, refer to plastic materials that have been previously used and processed through collection, sorting, cleaning, and reprocessing techniques to create new products or raw materials for manufacturing. These materials can originate from various sources, including post-consumer waste, post-industrial waste, and agricultural waste. The recycling process involves breaking down the used plastic into smaller pieces or melting it down, removing contaminants, and transforming it into new plastic products or raw materials for manufacturing.

1. A trigger pump dispenser comprising
a main body, comprising
a pump chamber
an inlet port in communication with said pump chamber
an outlet port in communication with said pump chamber
an inlet valve seated between the pump chamber and the inlet port
a outlet valve seated between the pump chamber and the outlet port
a piston, seated in the pump chamber, for defining a variable volume in said pump chamber and movable between a retracted position of larger chamber volume and an inserted position of lesser chamber volume,
wherein the pump chamber has a conical shape.

2. A trigger pump dispenser according to claim 1, wherein the conical shape of the pump chamber has a half-angle from 0.1° to 0.5°.

3. A trigger pump dispenser according to claim 2, wherein the conical shape of the pump chamber has a half-angle from 0.2° to 0.4.

4. A trigger pump dispenser according to claim 1, wherein the piston comprises a first sealing lip and a second sealing lip and wherein ratio between the length of the first sealing lip and the length of the second sealing lip is from 2 to 6.

5. A trigger pump dispenser according to claim 4, wherein the ratio between the length of the first sealing lip and the length of the second sealing lip is from 3 to 5.

6. A trigger pump dispenser according to claim 1, wherein the piston comprises a first sealing lip and a second sealing lip and wherein the ratio between the length of the first sealing lip and the thickness of the first sealing lip is from 9 to 18.

7. A trigger pump dispenser according to claim 6, wherein the piston comprises a first sealing lip and a second sealing lip and wherein the ratio between the length of the second sealing lip and the thickness of the second sealing lip is from 3.5 to 8.

8. A trigger pump dispenser according to claim 1, wherein the piston comprises a first sealing lip and a second sealing lip and wherein the ratio between the length of the first sealing lip and average diameter of the pump chamber is from 0.51 to 0.61.

9. A trigger pump dispenser according to claim 1, wherein the piston comprises a first sealing lip and a second sealing lip and wherein the ratio between the length of the second sealing lip and average diameter of the pump chamber is from 0.08 to 0.18.

10. A trigger pump dispenser according to claim 1, wherein the piston includes a base comprising ribs.

11. A trigger pump dispenser according to claim 1, wherein the main body and the piston are formed from 10 to 100 weight percent of recycled plastic.

12. A trigger pump dispenser according to claim 11, wherein the main body and the piston are formed from 30 to 100 weight percent of recycled plastic.

13. A trigger pump dispenser according to claim 12, wherein the main body and the piston are formed from 50 to 100 weight percent of recycled plastic.

14. A trigger pump dispenser comprising a main body which comprises a conical pump chamber, the main body includes an inlet port and an outlet port that are in communication with the pump chamber, the dispenser comprises a piston, seated in the pump chamber, for defining a variable volume in said pump chamber and movable between a retracted position of larger chamber volume and an inserted position of lesser chamber volume, the pump chamber comprises a venting hole, an inlet valve is seated between the pump chamber and the inlet port, the inlet valve is adapted to open the inlet port when liquid to be dispensed is drawn into the pump chamber through the inlet port as the pump chamber volume increases when the piston is moved from the inserted position to the retracted position, an outlet valve is seated between the pump chamber and the outlet port, the outlet valve is adapted to open the outlet port when the pump chamber decreases in volume as liquid therein is dispensed through the outlet port and adapted to close when the pump chamber increases in volume.

15. A trigger pump dispenser according to claim 14, wherein the conical pump chamber comprises an outer wall. the half-angle of the conical pump chamber is in the range 0.1° to 0.5°, the half-angle is formed by the intersection of a plane passing through one of the sloping sides of the conical pump chamber and the revolution axis of the pump chamber.

16. A trigger pump dispenser according to claim 14, in which the main body includes a tube retainer, and in which the tube retainer is integrally formed with the main body or in which the tube retainer fits into a portion of the main body.

17. A trigger pump dispenser according to claim 14, wherein the trigger pump dispenser comprises a trigger and biasing elements for biasing the trigger towards its starting position, the trigger is coupled with the piston and is movable from a starting position at which the piston is in the retracted position and a depressed position at which the piston is in the inserted position, the trigger and the biasing elements are formed in the same component.

18. A trigger pump dispenser according to claim 14, wherein the piston is a single piece comprising a piston rod, a piston base, a first sealing lip and a second sealing lip.

19. A trigger pump dispenser according to claim 18, wherein the first sealing lip is defined by length and a thickness, the length of the first sealing lip corresponds to the perpendicular distance between the two planes of the bases of the conical frustum being the first sealing lip, the thickness of the first sealing lip is the distance perpendicular to its slant height, and wherein the second sealing lip is defined by a length and a thickness, the length of the second sealing lip corresponds to the perpendicular distance between the two planes of the bases of the conical frustum being the second sealing lip, the thickness the second sealing lip is the distance perpendicular to its slant height, in which the ratio between the length of the first sealing lip and the length of the second sealing lip is in the range 2 to 6, wherein the ratio between the length of the first sealing lip and the thickness of the first sealing lip is from 9 to 18, and wherein the ratio between the length of the second sealing lip and the thickness of the second sealing lip is from 3.5 to 8.

20. A tigger pump dispenser according to claim 18, wherein the ratio between the length of the first sealing lip and average diameter of the pump chamber is from 0.51 to 0.61. and wherein the ratio between the length of the second sealing lip and average diameter of the pump chamber is from 0.08 to 0.18.
